(19) United States
(12) Patent Application Publication
(10) Pub. No.: US 2010/0136210 A1
(43) Pub. Date: Jun. 3, 2010

(54) SANITARY ARTICLE COMPRISING LACTOBACILLI IN A HYDROPHILIC CARRIER

(75) Inventors: Ulla Forsgren-Brusk, Pixbo (SE); Ulrika Husmark, Molnlycke (SE); Bo Runeman, Partille (SE)

Correspondence Address: BUCHANAN, INGERSOLL & ROONEY PC, POST OFFICE BOX 1404, ALEXANDRIA, VA, 22313-1404, US

(73) Assignee: SCA Hygiene Products AB, Goteborg (SE)

(21) Appl. No.: 12/597,504

(22) PCT Filed: Jun. 21, 2007
(86) PCT No.: PCT/SE07/50453

§ 371 Date: Oct. 26, 2009

(51) Int. Cl. B05D 7/00

(52) U.S. Cl. 427/2.3

(57) ABSTRACT

A sanitary article such as a sanitary napkin, a panty liner, an incontinence protector, a diaper, an incontinence pad, a feminine insert, a tampon, hygiene tissue or the like, includes lactic acid producing bacteria being dispersed in a carrier. The dispersion is applied on or in parts of the final sanitary article. The carrier is a hydrophilic carrier and the dispersion has a viscosity of 110 Pa·s or lower, at a temperature of 35° C., and a water activity below 0.2.

### TECHNICAL FIELD

The present invention relates to sanitary articles, such as sanitary napkins, panty liners, incontinence protectors, diapers, hygiene tissues, which comprises a lactic acid producing bacteria dispersed in a hydrophilic carrier.

### BACKGROUND OF THE INVENTION

The urogenital area harbors a complex microbial ecosystem comprising more than 50 different bacterial species (Hill et al., Scand. J. Urol. Nephrol. 1984; 86 (suppl.) 23-29). The dominating species in this area for fertile women are lactic acid producing bacteria belonging to the genus Lactobacillus. These lactic acid producing members are important for retaining a healthy microbial flora in these areas, and act as probiotic bacteria with an antagonistic effect against pathogenic microbial species. Lactic acid producing bacteria inhibit growth and colonization by other microorganisms by occupying suitable niches for colonization, by forming biofilms and competing for available nutrients, thereby excluding colonization by harmful microorganisms. Also, the production of hydrogen peroxide, specific inhibiting substances, such as bacteriocines, and organic acids (including lactic acid and acetic acid) that lower the pH, inhibit colonization by other microorganisms.

The microbial ecosystem of a healthy individual can be disturbed by the use of antibiotics, during hormonal changes, such as during pregnancy or use of contraceptives with estrogen, during menstruation, after menopause, in people suffering from diabetes etc. Also, microorganisms may spread from the anus to the urogenital area, this results in a disturbance of the normal microbial flora and leaves the individual susceptible to microbial infections such as vaginitis, candida infections, urinary tract infections and skin infections. Microorganisms commonly associated with these kinds of infections belong to the genera Escherichia, Enterococcus, Pseudomonas, Proteus, Klebsiella, Streptococcus, Staphylococcus, Gardnerella and Candida. Women are at particular risk due to their shorter distance between the anus and the urogenital tract; specially at risk are young women, who not yet have a well developed microflora in the urogenital area and older women, who in most cases no longer have a protective flora.

Similarly to the urogenital area, the skin is colonized by an array of organisms, which forms its normal flora. The numbers and identity of the organisms vary between different skin sites. This, together with the skin's structural barrier, provides the host with an excellent defense against invading microbes. The number of bacteria on the skin varies from a few hundred per cm² on the arid surfaces of the forearm and back, to tens of thousands per cm² on the moist areas such as the axilla and groin. This normal flora plays an important role in preventing foreign organisms from colonizing the skin, but it to needs to be kept in check, in order to avoid skin infections.

Staphylococcus aureus is the most common cause of minor skin infections, such as boils or abscesses, as well as more serious post-operative wound infection. Treatment involves drainage and this is usually sufficient for minor lesions, but antibiotics may be given in addition when the infection is severe and the patient has fever.

Other common skin infections are caused by Streptococcus pyogenes (group A streptococci). The organisms are acquired through contact with other people with infected skin lesions and may first colonize and multiply on normal skin prior to invasion through minor breaks of the epithelium and the development of lesions.

Treatment with penicillin or erythromycin may be necessary to combat the infection.

Candida likes skin sites which are moist and warm and also rapidly colonizes damaged skin. Hence, the relative dryness of most areas of skin prevents the growth of Candida, which therefore are found in low numbers on healthy skin. Candida also colonizes the oral and vaginal mucosa and over-growth may result in disease in these sites. C. albicans is associated with diaper dermatitis. A study has shown that C. albicans induced lesions are remarkably influenced by pH, a lower skin pH giving less lesions (B. Runeman, Acta Derm Venereol 2000; 80: 421-424).

The administration of lactic acid producing bacteria to the urogenital area and the skin, in order to out-compete pathogenic species and facilitate reestablishment and maintenance of a beneficial microbial flora in these areas, has been found to be a successful means to treat and prevent microbial infections

It has been suggested that lactic acid producing bacteria can be delivered via absorbent products, such as diapers, sanitary napkin, incontinence guards, panty liners and tampons, as described in, for example, WO 92/13577, WO 97/02846, WO 99/17813, WO 99/45099 and WO 00/35502.

WO 04/105822 discloses a sanitary article comprising a film-shaped polymer matrix comprising lactic acid producing bacteria, which polymer matrix is dissolved when exposed to wet conditions. This however demands that the product is wetted before the lactic acid producing bacteria are transferred to the wearer.

Before the lactic acid producing bacteria are applied to absorbent products they are often freeze-dried and thus applied to the products in an inactive state, in order to become active the bacteria needs a certain amount of moisture. A common way to apply lactic acid producing bacteria in sanitary articles is to disperse the bacteria in a hydrophobic carrier in order to protect them from moisture and thus a too early activation as e.g. described in EP 1 3 22 246. It has however been discovered that use of a hydrophobic carrier for the lactic acid producing bacteria may delay the activation of the bacteria in such a way that they have not reached a full-grown state and an optimal efficiency when they are exposed to the wearer of the sanitary article. There is even a possibility that the hydrophobic carrier substantially inhibit the activation by enclosing the bacteria in a complete hydrophobic environment.

In order to protect and simplify the handling of the lactic acid producing bacteria, freeze-dried bacteria are often mixed with protective agents, such as sugars, and granules are formed of these mixtures. When these granules are mixed in a hydrophobic carrier the granules will not integrate with the carrier and the dispersion will be perceived as gritty and unpleasant by the user.

A further problem with a hydrophobic carrier is that when the product is folded and packed the hydrophobic substance, wherein the bacteria is dispersed, sticks to the package or smears over the product in an undesired manner. If a hydrophobic substance is smeared over the topsheet of an absorbent article, this will have a negative impact on the absorbance due to clogging of the pores in the topsheet.

WO 03/053397 discloses the use of a hydrophilic carrier for lactic acid producing bacteria, however there is no control of the moisture level in the carrier.

Consequently, there is a need for sanitary articles comprising lactic acid producing bacteria, said bacteria having an improved and more rapid beneficial effect and at the same time ensure that the absorbent properties of the product is retained.

### SUMMARY OF THE INVENTION

In view of this prior art it is an object of the present invention to provide a sanitary article comprising lactic acid producing bacteria with an enhanced effect. It is also an object of the present invention that said sanitary article has satisfactory storage stability and to ensure the absorbent properties of the article.

The above defined problems are solved by the present invention by forming a dispersion of a hydrophilic carrier and lactic acid producing bacteria, and that the resulting dispersion has a viscosity of 110 Pa·s or lower, at a temperature of 35° C., and a water activity below 0.2, and applying this dispersion in or on a sanitary article.

In one embodiment the dispersion has a viscosity between 10 Pa·s and 80 Pa·s, at a temperature of 35° C., preferably between 30 Pa·s. and 70 Pa·s.

In a further embodiment the dispersion has a water activity below 0.15, preferably lower than 0.1.

In a still further embodiment said dispersion is added in an amount of 0.05-3 g to the sanitary article.

In one embodiment the hydrophilic carrier contains an effective amount of viable lactic acid producing bacteria after 3 months of storage in 25° C. and 65% relative humidity, preferably the hydrophilic carrier contains an effective amount of viable lactic acid producing bacteria after 6 months of storage in 25° C. and 65% relative humidity.

In one aspect said dispersion is applied by extrusion or slot coating

In one embodiment the hydrophilic carrier is a monosubstituted alcohol, a diol, a triol or a polyol, or mixtures thereof, preferably the hydrophilic carrier is glycerol.

In a further embodiment said dispersion is in the form of droplets forming a stable emulsion in a lipid phase.

In one embodiment the sanitary article is an absorbent article, comprising a longitudinal and a transverse direction, a top sheet, and an absorbent structure.

In a further embodiment said dispersion is applied centrally in the transverse and the longitudinal direction of said absorbent article.

In a still further embodiment said dispersion is applied centrally in the transverse direction and slightly off-set in the longitudinal direction of said absorbent article.

In another embodiment said sanitary article is a hygiene tissue.

In one aspect the sanitary article according to the invention is enclosed in a water-vapour impermeable cover.

In another aspect when the sanitary article is an absorbent article, said dispersion is enclosed in a water-vapour impermeable pocket being located on the wearer facing side on said absorbent structure and not comprising said absorbent structure.

In one embodiment said lactic acid producing bacteria is Lactobacillus plantarum 931 and/or Lactobacillus Fermentum Ess-1.

### DEFINITIONS

The term “sanitary article” refers to products that are placed against the skin of the wearer to absorb and contain body exudates, like urine, faeces and menstrual fluid, and also to products that are used for cleaning and caring of the skin and the urogenital area and that also can be used to deliver lactic acid producing bacteria to these areas. The invention mainly refers to disposable sanitary articles, which means articles that are not intended to be laundered or otherwise restored or reused as a sanitary article after use. Examples of disposable sanitary articles include wet wipes, dry wipes, feminine hygiene products such as sanitary napkins, panty liners, sanitary panties and tampons; diapers and pant diapers for infants and incontinent adults; incontinence pads; diaper inserts and the like.

The term “absorbent article” refers to products that are placed against the skin of the wearer to absorb and contain body exudates, like urine, faeces and menstrual fluid. The invention mainly refers to disposable absorbent articles, which means articles that are not intended to be laundered or otherwise restored or reused as an absorbent article after use. Examples of disposable absorbent articles include feminine hygiene products such as sanitary napkins, panty liners and sanitary panties; diapers and pant diapers for infants and incontinent adults; incontinence pads; diaper inserts and the like.

By “hygiene tissue” is meant any device for wiping, cleaning and caring of the skin and the urogenital area which also can be used to deliver a microbe-inhibiting composition to these areas, for instance a wet wipe, dry wipe, washcloth, patch, towelette, napkin, and the like.

“Water activity” a_{w} measures the vapour pressure generated by the moisture present in a hygroscopic product.

a_{w}=p/pₛ, where:
p: partial pressure of water vapour at the surface of the product
pₛ: saturation pressure, or the partial pressure of water vapour above pure water at the product temperature

Water activity reflects the active part of moisture content or the part which, under normal circumstances, can be exchanged between the product and its environment.

Water activity is usually defined under static conditions of equilibrium. Under such conditions, the partial pressure of water vapour (p) at the surface of the product is equal to the partial pressure of water-vapour in the immediate environment of the product. Any exchange of moisture between the product and its environment is driven by a difference between these two partial pressures.

By “dispersion” is meant a mixture of at least two phases, which are insoluble or limitedly soluble in one another, wherein one phase forms solid particles, liquid droplets or gas bubbles in the other phase.

An “essentially hydrophilic” carrier according to the invention is one which comprises one or more hydrophilic group, which makes it possible for the carrier to interact with a polar solvent.

By a “water-vapour impermeable” pocket is meant a pocket whose impermeability is so high that said pocket will not allow more moisture to enter into the pocket than that at which uptake the dispersion of a lactic acid producing bacteria in a hydrophilic carrier present in the pocket will essentially retain their properties. This means that the pocket may have a highest WVTR (Water Vapour Transmission Rate) of 6 g/m²/24 h according to ASTME 398-83 at 37.8° C. (100° F.) and 90% relative humidity, preferably at most 4 g/m²/24 h, and more preferably at most 2 g/m²/24 h, even more preferably at most 1 g/m²/24 h and even more preferably at most 0.1 g/m²/24 h. The pocket used will also preferably protect the moisture-sensitive additives in such a way that said additives will retain their effect for at least 6 months and preferably for 9 months in 23° C. (73.4° F.) and 50% relative humidity after the packaging date.

The data and values mentioned with respect to WVTR (Water Vapour Transmission Rate) correspond to unsaturated values in accordance with the standard ASTME 398-83, which is generally applied in this field and is known to the person skilled in this art.

### DETAILED DESCRIPTION OF THE INVENTION

An object of the present invention is to provide sanitary articles suitable for absorbing and containing body exudates, like urine, faeces and menstrual fluid, and also to cleaning and caring of the skin and the urogenital area and simultaneously release lactic acid producing bacteria that is to be transferred to the skin. A further object is to ensure the absorbent properties of the sanitary articles.

The present invention pertains to solve the problem of growth, colonization and/or survival of pathogenic microorganisms in the urogenital area and on the skin by using said sanitary article. This problem is solved in the present invention by applying a dispersion comprising lactic acid producing bacteria in a hydrophilic carrier, said dispersion having a viscosity of 110 Pa·s or lower, at a temperature of 35° C., and a water activity below 0.2, in or on a sanitary article.

A hydrophilic carrier, for instance dried glycerol, is an advantageous carrier for lactic acid producing bacteria since it gives a rapid activation of the bacteria, the rapid activation allows the bacteria to become fully grown and effective when they are exposed to the urogenital area.

It is important that the lactic acid producing bacteria are viable when they are exposed to the wearer of the sanitary article, so the lactic acid producing bacteria have to retain viability during transport and storage of the products, preferably the hydrophilic carrier contains an effective amount of viable lactic acid producing bacteria after 3 months of storage in 25° C. and 65% relative humidity, and more preferably the hydrophilic carrier contains an effective amount of viable lactic acid producing bacteria after 6 months of storage in 25° C. and 65% relative humidity.

An effective amount of lactic acid producing bacteria is in the present invention considered to be at least 10³ viable lactic acid producing bacteria, preferably 10⁴ viable lactic acid producing bacteria.

Lactic acid producing bacteria rapidly lose viability under semi-moist conditions, and it is therefore important that the bacteria are not uncontrollably exposed to moisture. With “semi-moist” conditions is meant that the water activity (aw) is between about 0.2 and about 0.9. Thus in order to retain the viability of the bacteria it is of importance that the water-activity of the dispersion is less than 0.2, preferably less than 0.15 and most preferably less than 0.1. Said dispersion may be dried in order to reduce the water activity, for example in a chamber using dry air at a temperature of about 30° C.

The water activity of the dispersion is measured using aW-instrument from ADAB Analytical Devices AB, Stockholm, Sweden. Serial TE 8105, Model Series 3 TE.

There are as seen several opposing problems to be solved at the same time. Both to achieve good storage stability for the bacteria by enclosing the bacteria in a protective carrier, but at the same time not surrounding the bacteria with a completely impervious coating so that the bacteria stay inactive. It has earlier been considered difficult to solve all these problems with a combined solution in a satisfactory way. The present invention however solves these problems by balancing the contact of the lactic acid producing bacteria with moisture. Since the carrier is liquid to semisolid, the transfer and thus the beneficial effect of the lactic acid producing bacteria to the wearer will also be immediate.

The dispersion preferably has a viscosity of 110 Pa·s or lower, at a temperature of 35° C., during use of the sanitary article since this facilitates the transfer of the dispersion from the article to the wearer during use. Preferably the dispersion has a viscosity of between 10 Pa·s and 80 Pa·s, since this gives an advantageous adherence to the skin.

The viscosity is measured with a controlled stress rheometer (TA instruments AR 1000-N) according to standard procedure. The viscosity is measured at a temperature interval of 20-50° C. at an interval of 10° C./min, Shear rate 10/s, a 40 mm 1° steel cone and a gap of 3 mm.

The hydrophilic carrier may be monosubstituted alcohols, diols, triols or polyols. Preferably the hydrophilic carrier is glycerol. The hydrophilic carrier may also be hexanol, heptanol, oleyl alcohol. The monosubstituted alcohols, diols, triols, polyols or said dispersion may, as described above, be dried in order to reduce the water activity, for example in a chamber using dry air at a temperature of about 30° C.

As said before, granules comprising lactic acid producing bacteria and protective agent, such as sugars, is a convenient way to handle the lactic acid producing bacteria. An advantage with using a hydrophilic carrier is that said granules integrate with the carrier and the dispersion will therefore feel smooth against the wearer's skin.

Lactic acid producing bacteria are cultivated in a broth comprising different nutrients for the bacteria, after concentration of these lactic acid (producing) bacteria there is still some remainder of said broth. Since this broth is hydrophilic, a hydrophilic carrier according to the invention gives the possibility to mix the lactic acid bacteria directly into the carrier without freeze-drying and milling them in beforehand. This is obviously advantageous in the production, since the steps of freeze-drying and milling can be avoided. This may also be very beneficial to the wearer since the smooth feeling of the dispersion is enhanced if the bacteria not have to be in a freeze dried state. Further advantage is that the bacteria are delivered as active intact bacteria to the wearer of the sanitary article.

A further advantage is that a hydrophilic carrier not impairs the absorbing properties of absorbent articles.

In order to further protect the lactic acid producing bacteria the dispersion may be applied as droplets in a hydrophobic phase. This may be achieved by mixing the hydrophobic phase, such as for example petrolatum, with glycerol and forming a stable emulsion.

The sanitary article according to the invention may be completely enclosed in a water-vapour impermeable package, an example of such a package may be found in EP 1 210 277.

The absorbent article according to the invention may also comprise a water-vapour impermeable pocket comprising the dispersion of lactic acid producing bacteria in a hydrophilic carrier.

The pocket may be located on top of the wearer facing side of the topsheet, but may also, be located between the topsheet and the absorbent structure or, as a less preferred embodiment, between the absorbent structure and the backsheet.

The water-vapour impermeable pocket or the may be produced, at least partially, from one or more polymers suitable for use in accordance with the invention, the polymers may be chosen from polyethylene, polypropylene, polyesters, polyethylene terephthalate, polyvinylchloride, polyvinyldichloride, cyclic olefinic copolymers, polyolefines, metallized polyolefines, ethylene vinylacetate copolymers, ethylene ethyl acrylate copolymers, ethylene butyl acrylate copolymers, polyamides, polyvinyl alcohol, ionomers or similar polymers. Aluminium foil, aluminium oxide or silicon oxide or the like is equally suitable materials for producing said material layer, an example of these latter three materials being Techbarrier S, V, H, T, AT, NR, NY Mitsubishi, Helional WTY (Amcor Flexibles), VA 535670 (metallised PE/PET) (Nordenia), 4364 (Schur-Flexible), Coex HDPE Surlyn (Schur-Flexible), Coex Cheerios (Schur-Flexible). Other materials that may be suitable to use in the laminate in accordance with the invention are plastic laminates with ceramic barriers, waxes, paper, lacquers and adhesives.

In order to ensure that the pocket will prevent the ingress of moisture, it is important that the pocket is completely closed with tight sealings so that the WVTR of the pocket will be at most 6 g/m²/24 h measured in accordance with ASTME 398-83 at 37.8° C. (100° F.) and 90% relative humidity, preferably at most 4 g/m²/24 h, and more preferably at most 2 g/m²/24 h, even more preferably at most 1 g/m²/24 h, and even more preferably at most 0.1 g/m²/24 h.

According to one aspect of the invention the length of said carrier member is 1-15 cm, preferably 2-8 cm, most preferably 2-5 cm. In a further aspect the width of said carrier member is 0.5-5 cm, preferably 0.8-3 cm, most preferably 1-2 cm.

Before using the absorbent article one of the material layers or of the water-vapour impermeable pocket should be removed or ruptured in order to expose the wearer or the article for the hydrophilic dispersion comprising lactic acid producing bacteria. This may be accomplished in many different ways, for example the pocket is opened by peeling of one of the material layers by squeezing and rupturing one of the material layers. The pocket may also be opened by a pull string having a free end and while the rest of the pull string is integrated into the pocket. Upon pulling the pull string the material layer/layers will be peeled of or ruptured.

If the ambient environment has a much higher humidity than the dispersion, it may be essential to enclose said dispersion to maintain the water activity at a constant low level.

The dispersion according to the invention typically comprises 2-98% hydrophilic carrier, 1-70% lactic acid producing bacteria and the remainder is protective agents, such as sugars.

A sanitary article according to the present invention typically is provided with lactic acid producing bacteria in amounts of about 10⁶-10¹¹ CFU per article. Preferably, the sanitary article will comprise about 10⁸-10¹⁰ CFU per sanitary article, although these amounts may vary depending on the specific application, product formulation and intended use.

Preferred lactic acid producing bacteria for the object of the present invention include bacteria from the genera Lactobacillus, Lactococcus and Pediococcus. Preferably the selected bacterium used is from the species Lactococcus lactis, Lactobacillus acidophilus, Lactobacillus curvatus, Lactobacillus fermentum or Lactobacillus plantarum. More preferably the bacterial strain is selected from Lactobacillus plantarum and/or Lactobacillus fermentum. Even more preferably the lactic acid producing bacterium is Lactobacillus plantarum 931 (deposition No. (DSMZ): 11918) and Lactobacillus fermentum Ess-1, deposited according to the Budapest Treaty at Deutsche Sammlung von Mikroorganismen und Zellkulturen GmbH (Mascheroder Weg 1b, D-38124 Braunschweig) and assigned accession number DSM17851 (depositor Essum AB, Box 3160, SE 90304 Umeå, Sweden, deposited on Jan. 6, 2006).

The sanitary article according to the invention typically comprises from 0.05 to 4 g of said dispersion, preferably 0.1-2 g of said dispersion.

In order to apply the dispersion of the hydrophilic carrier and lactic acid bacteria in a controlled and gentle manner preferable application methods are coating by extrusion, slot coating or application by cylinder. Other possible methods to apply the dispersion are for example by spraying or spiral spraying.

In one embodiment the sanitary article is a sanitary napkin comprising a liquid permeable topsheet, a liquid impermeable backsheet and an absorbent structure enclosed there between. The liquid permeable topsheet can be composed of a nonwoven material, e g spunbonded, meltblown, carded, hydroentangled, wetlaid etc. Suitable nonwoven materials can be composed of natural fibers, such as woodpulp or cotton fibres, manmade fibres, such as polyester, polyethylene, polypropylene, viscose etc. or from a mixture of natural and manmade fibres. The topsheet material may further be composed of tow fibres, which may be bonded to each other in a bonding pattern, as e.g. disclosed in EP-A-1 035 818. Further examples of topsheet materials are porous foams, apertured plastic films etc. The materials suited as topsheet materials should be soft and non-irritating to the skin and be readily penetrated by body fluid, such as urine or menstrual fluid.

The liquid impermeable backsheet may consist of a thin plastic film, e.g. a polyethylene or polypropylene film, a nonwoven material coated with a liquid impervious material, a hydrophobic nonwoven material, which resists liquid penetration. Laminates of plastic films and nonwoven materials may also be used. The backsheet material is preferably breathable so as to allow vapour to escape from the absorbent structure, while still preventing liquids from passing through the backsheet material.

The topsheet and the backsheet have a somewhat greater extension in the plane than the absorbent structure and extend outside the edges thereof to form projecting portions. The layers and are connected to each other within the projecting portions,

e g by gluing or welding by heat or ultrasonic. The topsheet and/or the backsheet may further be attached to the absorbent structure by any method known in the art, such as adhesive or welding by heat or ultrasonic etc. The absorbent structure may also be unattached to the topsheet and/or the backsheet.

Fastening means in the form of a region of an adhesive is provided on the side of the backsheet facing away from the wearer during use. The adhesive may releasably attach to the undergarment of the wearer. A release paper protects the adhesive region before use. The adhesive region may have any suitable configuration, such as elongate or transverse strips, dots, full-coated areas etc.

In other embodiments (not illustrated) of absorbent articles according to the invention other types of fasteners, like friction fasteners, tape tabs or mechanical fasteners like hook-and-loop fasteners etc may be used to fasten the articles to the underwear or around the waist of the wearer. Some absorbent articles are in the form of pants and therefore do not need special fastening means. In other cases the absorbent article is worn in special elastic pants without the need for additional fasteners.

The absorbent structure can be of any conventional kind. Examples of commonly occurring absorbent materials are cellulosic fluff pulp, tissue layers, highly absorbent polymers (so called superabsorbents), absorbent foam materials, absorbent nonwoven materials or the like. It is common to combine cellulosic fluff pulp with superabsorbents in an absorbent structure. It is also common to have absorbent structures comprising layers of different material with different properties with respect to liquid acquisition capacity, liquid distribution capacity and storage capacity. This is well-known to the person skilled in the art and does therefore not have to be described in detail. The thin absorbent bodies, which are common in today's absorbent articles, often comprise a compressed mixed or layered structure of cellulosic fluff pulp and superabsorbent. The size and absorbent capacity of the absorbent structure may be varied to be suited for different uses such as sanitary napkins, panty liners, adult incontinence pads and diapers, baby diapers, pant diapers, etc.

A hygiene tissue according to the invention may be composed of a matrix comprising any natural or synthetic fiber, such as rayon, cellulose, regenerated cellulose, polyester, polyolefine fibers, textile and the like, or foam, nonwoven, felt or batting, or combinations thereof.

It is understood that the sanitary article described above only represents non-limiting examples and that the present invention is not limited thereto, but can be used in any type of sanitary articles as defined above.

### Examples on how to Produce Probiotic Mixtures with Desired Low Water Activity and Blended in Hydrophilic Carrier

### Example 1

Lactobacillus plantarum 931 was grown over night in MRS broth. 15 g of the suspension was centrifuged to a pellet. The supernatant was removed and 15 g dry glycerol was added. The pellet was suspended in the glycerol. Water activity was below 0.15 and viable bacteria was measured to 7E7 CFU/ml

### Example 2

Lactobacillus plantarum 93 was grown over night in MRS broth. 32 g of the suspension was centrifuged to a pellet. The supernatant was removed and 40 g glycerol added and the pellet suspended in the glycerol. The suspension was centrifuged again and after removing the supernatant new dry glycerol was added. After suspension of the Lactobacillus in the glycerol, the amount of viable bacteria was 5.3E8 CFU/ml and the water activity below 0.15 (0.030).

Survival Study with Lactobacillus plantarum 931

2 g of freeze dried Lactobacillus plantarum 931 was mixed with glycerol, (water activity below 0.2). The samples were stored in sterile, brown, glass vials at room temperature in the dark at normal air humidity (varying from 30-60% relative humidity). To measure the amount of viable Lactobacillus plantarum 931 cells after different storage time, 1 g of sample was transferred to a stomacher bag and 9 ml of 0.9% NaCl was added. The bag was then run at hugh effect in Stomacher for 3 min. The content of the bag was transferred to test tubes, diluted when necessary in NaCl and cultured on MRS-plates at 37° C. in 5% CO₂ in air for 2 days. The results of the study are shown below in Table 1.

TABLE 1

| Time | 5 days | 16 days | 1 month | 2 months | 3 months | 4 months | 6 months |
|---|---|---|---|---|---|---|---|
| Amount of bacteria | 2.00E7 | 2.00E6 | 5.00E6 | 3.00E4 | 4.00E4 | 5.00E5 | 5.00E4 |
| survived (CFU per | | | | | | | |
| g formulation) | | | | | | | |

1-17. (canceled)

18. A method for producing a sanitary article containing lactic acid producing bacteria, the method comprising applying a dispersion comprising lactic acid producing bacteria and a carrier in which the lactic acid producing bacteria is dispersed, on or in a part of the sanitary article, wherein said carrier comprises a hydrophilic carrier and said dispersion has a viscosity of 110 Pa·s or lower, at a temperature of 35° C., and a water activity below 0.2, with the proviso that the method excludes utilizing lactic acid producing bacteria that has been previously freeze-dried.

19. The method according to claim 18, wherein said dispersion has a viscosity between 10 Pa·s and 80 Pa·s.

20. The method according to claim 18, wherein said dispersion has a water activity below 0.15.

21. The method according to claim 18, wherein said dispersion is added in an amount of 0.05-3 g.

22. The method according to claim 18, wherein said dispersion contains an effective amount of viable lactic acid producing bacteria after 3 months of storage in 25° C. and 65% relative humidity.

23. The method according to claim 18, wherein said dispersion contains an effective amount of viable lactic acid producing bacteria after 6 months of storage in 25° C. and 65% relative humidity.

24. The method according to claim 18, wherein said dispersion is applied by extrusion or slot coating.

25. The method according to claim 18, wherein said hydrophilic carrier is a monosubstituted alcohol, a diol, a triol or a polyol.

26. The method according to claim 25, wherein said hydrophilic carrier is glycerol.

27. The method according to claim 18, wherein said dispersion is in the form of droplets forming a stable emulsion in a lipid phase.

28. The method according to claim 18, wherein said sanitary article is an absorbent article comprising a longitudinal and a transverse direction, a top sheet, and an absorbent structure.

29. The method according to claim 28, wherein said dispersion is applied centrally in the transverse and longitudinal directions of said absorbent article.

30. The method according to claim 28, wherein said dispersion is applied centrally in the transverse direction and slightly off-set in the longitudinal direction of said absorbent article.

31. The method according to claim 18, wherein said sanitary article is a hygiene tissue.

32. The method according to claim 18, wherein said sanitary article is enclosed in a water-vapour impermeable cover.

33. The method according to claim 28, wherein said dispersion is enclosed in a water-vapour impermeable pocket being located on the wearer facing side on said absorbent structure and not comprising said absorbent structure.

34. The method according to claim 18, wherein said lactic acid producing bacteria is Lactobacillus plantarum 931 or Lactobacillus Fermentum Ess-1.
